(19) United States
(12) Patent Application Publication
(10) Pub. No.: US 2009/0171771 A1
(43) Pub. Date: Jul. 2, 2009

(54) METHOD, SYSTEM AND SOFTWARE FOR TALENT MANAGEMENT

(75) Inventors: Michael James Carden, Auckland (NZ); Mark Evan Hellier, Auckland (NZ)

Correspondence Address: FOLEY AND LARDNER LLP;SUITE 500, 3000 K STREET NW, WASHINGTON, DC, 20007, US

(73) Assignee: SONAR LIMITED

(21) Appl. No.: 12/097,506

(22) PCT Filed: Dec. 14, 2006
(86) PCT No.: PCT/NZ2006/000328

§ 371 Date: Oct. 21, 2008

(30) Foreign Application Priority Data
Dec. 16, 2005 (NZ) 544228

(51) Int. Cl. G06Q 10/00; G06F 3/048; G06F 7/06; G06F 17/30

(52) U.S. Cl. 705/11; 715/833; 715/769; 715/768

(57) ABSTRACT

A method of managing talent including the steps of a user dragging an icon representing an individual within a continuum of one or more dimensions to record the value of one or more attributes of the individual; and refining the position of the icon within the continuum with reference to an objective standard; wherein each dimension corresponds to an attribute.

### FIELD OF INVENTION

The present invention relates to a method, system and software for managing talent within an organisation. More particularly, but not exclusively, the present invention relates to a method, system and software for managing talent within an organisation by assisting a user to evaluate an individual by positioning an icon representing an individual to determine a factor for the individual.

### BACKGROUND TO THE INVENTION

Talent Management is the practice and process of ensuring an organisation has the capability and capacity to deliver both the operational and strategic goals of that organisation using the most appropriate resources.

Talent are all individuals within an organisation irrespective of their current position or ranking. Managing talent applies to work and understanding around those with poor performance and limited potential just as it does the star performers and high potential employees.

Talent in an organisation is measured as a combination of performance and potential; performance is a measure of how well an individual is doing today and potential is a measure of how well the individual is likely to do in the long term. To further define performance and potential each can be broken down into a set of factors, which are attributes or behaviours that the organisation believes are important for staff to have strength in.

One existing method in HR for measuring factors of an employee uses scales to rating the employee. This method has generally been implemented as a linear method for rating people between one and five with attached definitions such as “one=poor” through to “five=exceeds expectations”.

The disadvantage of using scales is inaccuracy due to the arbitrary and non-supported way that users input data. Differences in the understanding of definitions and emotional bias when providing a rating often mean that the ratings provided by the user do not reflect accurate measurement of actual achievement. For example, the definition of a “good” performer can be quite different in terms of scale and relativity across a number of different managers. This becomes significant, particularly when attempting to establish a relative picture of capability and talent across all business units within an entire organisation.

In addition, the scales utilised in HR are generally not continuous. Often the only rating choices available are integers. This makes it difficult to differentiate between people who have “close” but not identical levels of performance.

These scales have other significant disadvantages when users are trying to ascertain relative positioning for many employees. A manager evaluating an employee generally only has the information in front of them relating to a specific employee and they are unable to quickly understand and compare where other employees have been rated.

Furthermore, an important aspect of understanding an employee's performance is with reference to change of performance over time. Existing HR systems do not provide easy access to historical information to help a manager make conclusions about an employee's performance. For instance, a sales person who has a three month period of terrible sales performance after a six year period of consistently good performance is very different than a sales person who has had terrible sales performance ever since they started with the company.

Often these problems can only be rectified by searching though other documents or bringing separate evaluations of other employees up on the screen one by one.

It is an object of the present invention to provide a method for managing talent which overcomes the limitations of the above methods, or to at least provide the public with a useful choice.

### SUMMARY OF THE INVENTION

According to a first aspect of the invention there is provided a method of managing talent including the steps of:
i) a user dragging an icon representing an individual within a continuum of one or more dimensions to record the value of one or more attributes of the individual; and
ii) refining the position of the icon within the continuum with reference to an objective standard;
wherein each dimension corresponds to an attribute.

The method may include the step of obtaining the objective standard through the use of a pre-defined questionnaire.

Preferably, the attributes are related to human resource metrics.

It is preferred that the continuum is a one dimension slider. Alternatively and less preferred, the continuum is a two dimension grid.

The method may include the step of displaying a plurality of icons within the continuum, each icon representing a unique individual.

The method may include the step of displaying a plurality of historical icons, the position of each icon corresponding to the historical values of the attributes for the individual. Preferably, at least some of the historical icons are visually faded dependent on the age of the historical values. The step of displaying a plurality of historical icons may dependent on a user action. The user action may be placing a pointer over the icon. The user action may be activating the icon.

In a preferred embodiment the step of refining the individual utilises a questionnaire to increase the accuracy of positioning of the individual.

The method may include the step of displaying further detail about the individual in response to a user action.

The method preferably includes the step of displaying a plurality of sliders within a single window, each slider corresponding to a unique attribute and each slider including the display of an icon representing the individual, such that a user can assess multiple attributes of the individual at one time.

The attributes may relate to performance or potential metrics.

According to another aspect of the invention there is provided a method of analysing an individual for managing talent including the steps of:
i) displaying a first graphical representation of a first set of data of an individual in a first shade of a colour; and
ii) displaying a second graphical representation of a second set of data for the individual in a second shade of the colour;
wherein the first set of data relates to the individual at an later time than the second set of data, and the second shade is lighter than the first shade.

It is preferred that the first and second graphical representations are icons displayed according to the first aspect.

According to other aspects of the invention there is provided a system and software arranged for performing the steps of the method.

### BRIEF DESCRIPTION OF THE DRAWINGS

Embodiments of the invention will now be described, by way of example only, with reference to the accompanying drawings in which:

FIG. 1: shows a graphical representation of an icon on a slider according to a method of the invention.

FIG. 2: shows a definition text bubble provided for an individual on the slider.

FIG. 3: shows a bubble help and questionnaire button once the individual is moved to a position on the slider

FIG. 4: shows an example of a questionnaire provided to refine the position of the individual on the slider.

FIG. 5: shows a graphical representation of multiple icons on a slider, each icon corresponding to a separate individual, according to a method of the invention.

FIG. 6: shows a graphical representation of multiple icons on a slider, each icon representing the evaluation of an individual at a different time, according to a method of the invention.

FIG. 7: shows a graphical representation of multiple icons on a slider, each icon representing the evaluation of an individual by different persons, according to a method of the invention.

FIG. 8: shows a diagram illustrating how the invention may be deployed on hardware.

### DETAILED DESCRIPTION OF PREFERRED EMBODIMENTS

The present invention relates to a method, software and system for managing talent in an organisation including the positioning of an icon representing an individual in relation to an attribute.

The present invention will be described in relation to a company, and the factors of employees within that company. However, it will be appreciated by those skilled in the art that the method may be applied to other organisations.

The present invention will be described in relation to the use of a one dimensional continuum graphically represented as a slider. It will be appreciated that two-dimensional continuums could be used as well to permit the definition of two factors at once. However, a single-dimensional slider is preferred due to its visual clarity and ease of use.

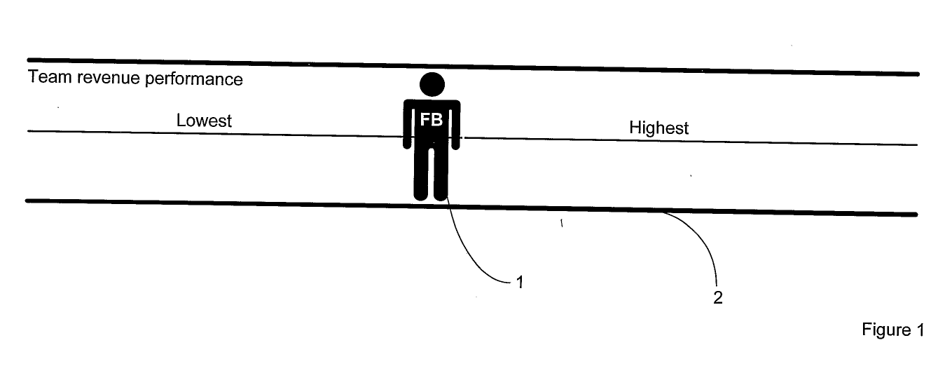

Referring to FIG. 1, an employee in the organisation is graphically represented as a “people icon” 1 on a sliding scale 2. The scale used for the slider is segmented by definitions of performance and achievements against the relevant factor.

It will be appreciated that any factor can be measured. However, the preferred implementation uses performance and potential factors.

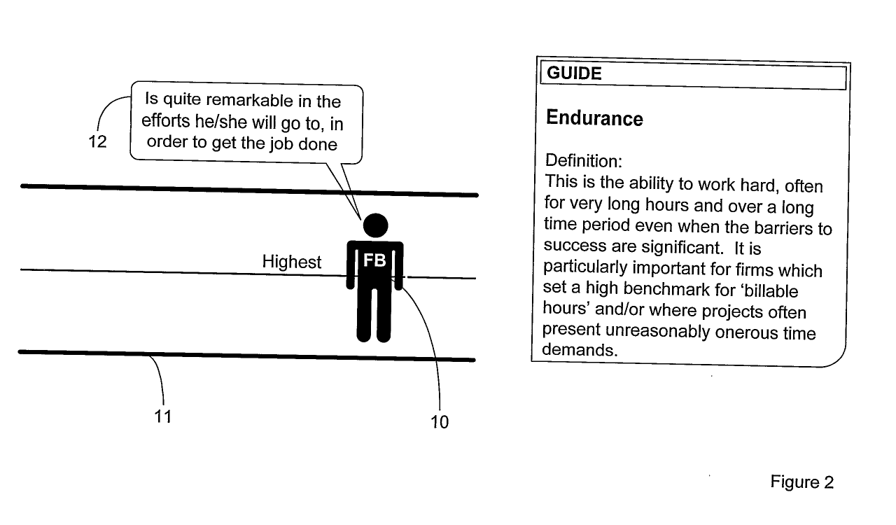

Referring to FIG. 2, the “people icon” 10 is moved through the different scales of competence by the user by clicking on the “people icon” and dragging the icon to the left or right on the slider 11. As the individual moves through the different segments, a definition 12 appears of that segment and what placing that employee there would mean in the context of their evaluation.

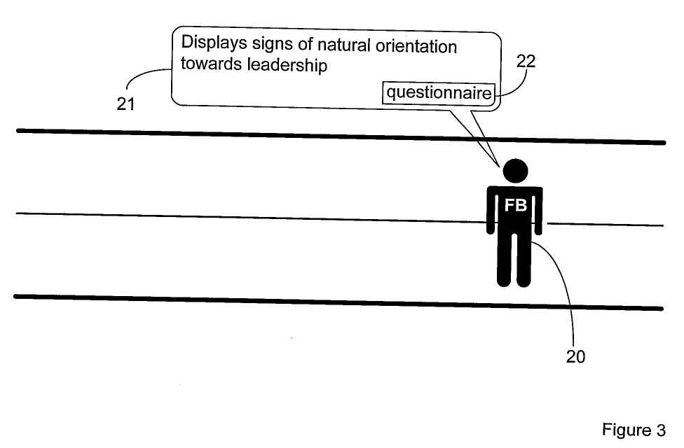

Referring to FIG. 3, when the “people icon” 20 is dragged and dropped to the required or desired location, a bubble 21 (bubble help) appears above the “people icon” and displays the consequent rating or definition attributable to that employee if they are left in that position.

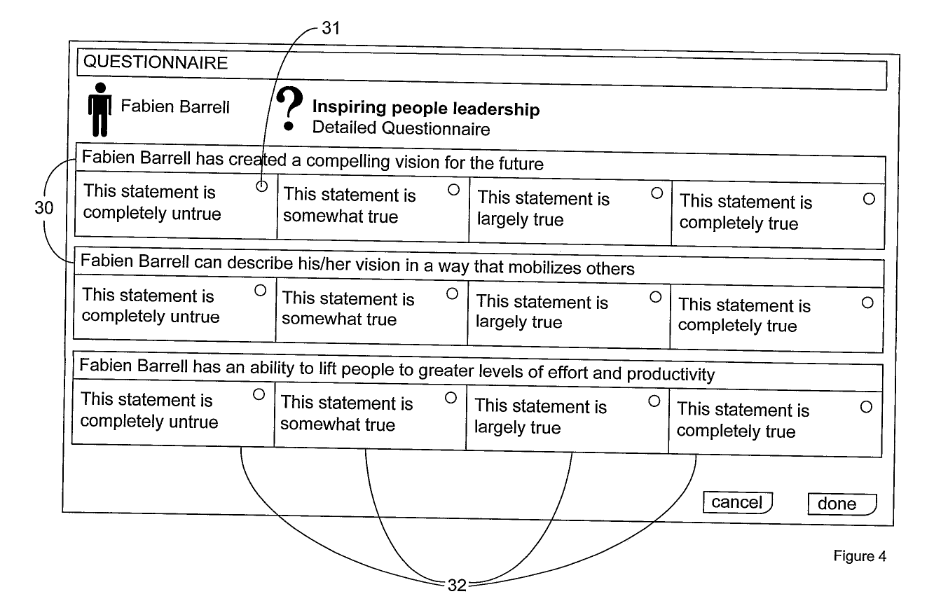

Also visible in the bubble is a button 22 labelled “questionnaire”. Pressing this button takes the user to a pre-defined questionnaire page as shown in FIG. 4. This is where the user can be prompted to answer factual and objective questions 30 around related topics and measurable aspects of performance against that factor. That is, an objective standard is obtained through the user responding to the predefined questionnaire.

For example, if the factor was the ability to achieve “sales targets”, the questionnaire may require the user to enter the achievement of sales targets for that individual. For example, has the employee met 100% of their required sales target, 50% or 150%? A radio button 31 within the questionnaire can be pressed to select the relevant level of achievement.

The questionnaire can be customised for the organisation and can provide questions for ratings 32 on a number of factual or supporting measures such as actual achievement against sales targets or customer satisfaction rating results.

Once the questionnaire process is completed, the answers will determine for the user a nominated position on the slider automatically. In other words the icon will move itself to the position that is defined by answering the factual questions in the questionnaire. This refinement process ensures that initial evaluation is not only objective, but can also be supported and validated by factual information.

The user may then alter the evaluation and positioning of the slider but it will provoke a number of questions, particularly if the slider has moved automatically a significant distance from where the user has evaluated employee performance against the competence.

The advantage of “bubble help” combined with the questionnaire feature and the visual nature of the slider using “people icons”, is a method which allows for ease of interaction, user support online in relation to HR definitions and performance scales, detailed evaluation and validation through the questionnaire, automatic questioning of the user's initial positioning of an employee on the slider, and the theoretical positioning using a questionnaire as defined by the company's requirements.

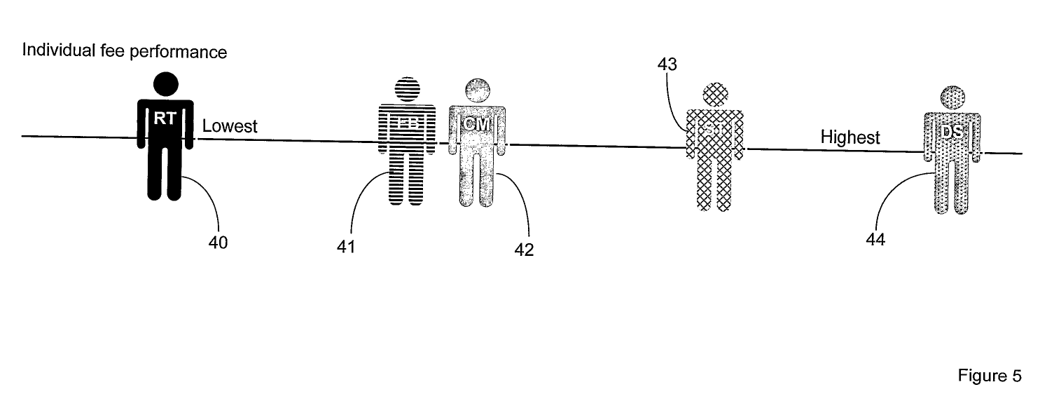

FIG. 5 shows an implementation of the method where multiple employees (40, 41, 42, 43, and 44) can be manipulated on the same slider. This means that a user, when dealing with their team or a particular group of individuals, can receive and work on the basis of an immediate relativity to any decision they make around the placement of an employee in comparison to other employees in that business unit.

The ability to display multiple employees in conjunction with the use of subjective measurement and objective questionnaires provides a significant refinement of the evaluation process. It provokes the user to think very carefully in a “real world” environment about their comparative ratings of individuals, as they see them in the workplace and as they have performed against the defined factors.

Multiple sliders across multiple factors can be displayed within the same screen. This provides a user with the ability to evaluate all the factors in one place and, if they desire, work with that set of information across multiple employees as well.

The sliders are continuous. This provides the advantage that an employee can be dragged and dropped to any point on the slider (not just integers). This provides users with the ability to differentially rate people who have “close” but not identical levels of performance.

One advantage of the invention is the ability to provide for the rapid and consistent input of evaluative data around an employee's performance.

The input of data is rapid due to the intuitive nature of the method and because it directly relates the manager's thinking about the rating of an employee to a quick and simple way of providing input. Previous systems to transfer this thinking are generally text and table based requiring the user to type large amounts of data or select check boxes that do not provide graphical feedback to the user in terms an individual's positioning relative to other team members.

The method of the invention increases the level of consistency across evaluations by providing interactive support to the user in terms of the definition of positioning an employee on various parts of the slider scale. The main aspects of the interactive support are the “bubble help” and interactive questionnaires.

The result of a user specifying the position of the employee on one or more sliders, each slider corresponding to a factor is an evaluation for that employee.

When the user, or another user has created an evaluation for that same employee at one or more times in the past, that data can be used to show change in time of the employee.

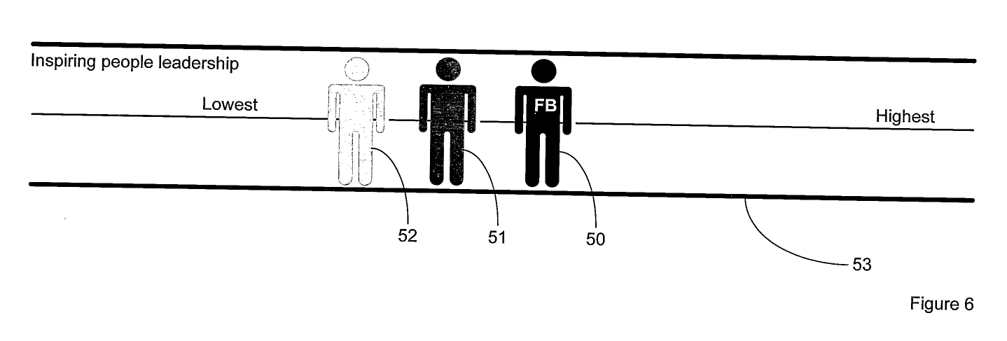

Referring to FIG. 6, the method shows change in time by fading the data that is historical. The method displays an icon 50 representing a current rating for the employee and historical ratings in form of “person icons” 51 and 52 for the employee on the same slider that is being used to rate the employee for the current evaluation. The older an evaluation is, the more faded its corresponding icon appears on the slider.

This provides the user with the ability to view the previous ratings on that factor for that employee, and understand where they have progressed/regressed to since the last evaluation period. This is particularly useful in determining that a fair and accurate evaluation has been given, and also to allow a manager to respond to the situation armed with the additional knowledge that an employee is improving in performance or regressing against a certain factor.

The advantage of faded icons within the method of the invention is the display of a clear, simple and useful visual picture of an employee's current status and their progression/regression.

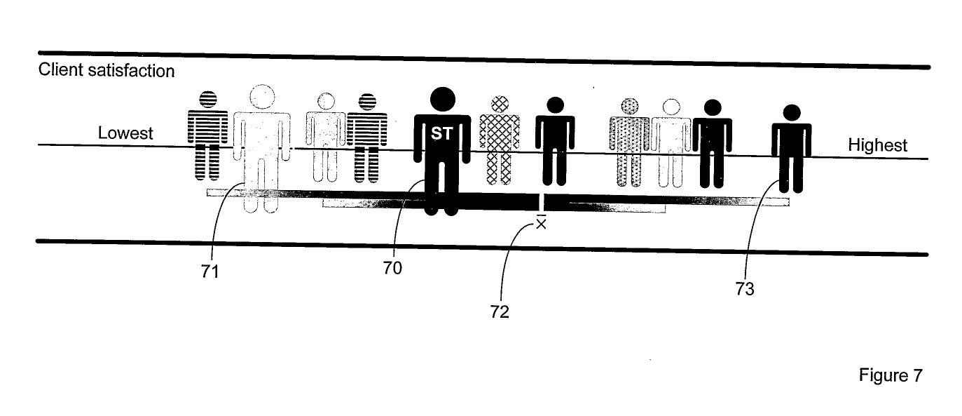

Referring to FIG. 7, the method shows multiple ratings for an individual on a single slider. The method displays an icon 70 representing the final rating decision given by a rating manager. Additional “person icons”, for example 71 and 73, are shown to indicate ratings provided by other people in order to provide additional information to the rating manager so that an informed decision can be made on the final rating. Any number of additional icons may be shown. For example, the display may show the rating of the individual 71 as provided by the individual themselves, i.e. a ‘self-rating’. In this example, the ‘self-rating’ is shown as a larger icon than the others because it is considered to have more significance. It will be understood that ratings from other people may be considered to be more significant and so will be shown as a larger icon.

Alternatively, a rating input may be provided by peers, customers, staff or other managers of the individual (e.g. 73). Information concerning the rating of the individual taken from other sources is gathered when the alternative sources login to the system.

Also shown on the display is the mean rating value 72 taken from all of the ratings received. The mean rating vale may also help the rating manager to come to an informed decision as to the final rating position of the individual.

In an alternative method, an icon representing an individual is automatically positioned on a slider by using different forms of information. Any information that can be defined by using a mathematical percentage can be used to position the icon. A questionnaire may be used to obtain the information, or the information may be obtained from another source, such as the companies accounting records. Non limiting examples of the type of information that can be used are the percentage of a revenue target that has been obtained by the individual, or the percentage of the number of goals set by the individual's manager that have been reached by the individual.

When the information has been obtained, the icon representing the individual is moved to the calculated position on the slider. An additional icon is displayed on the icon representing the individual to show how much information has been used to create the rating.

In a further alternative method, notes are attached to an icon on a slider representing an individual so that they can be displayed when viewing the slider. The notes may be used, for example, to explain the ratings being indicated, to capture comments from any persons who have provided input to obtain the displayed ratings, to set goals and targets for the future or to plan development of the individual etc.

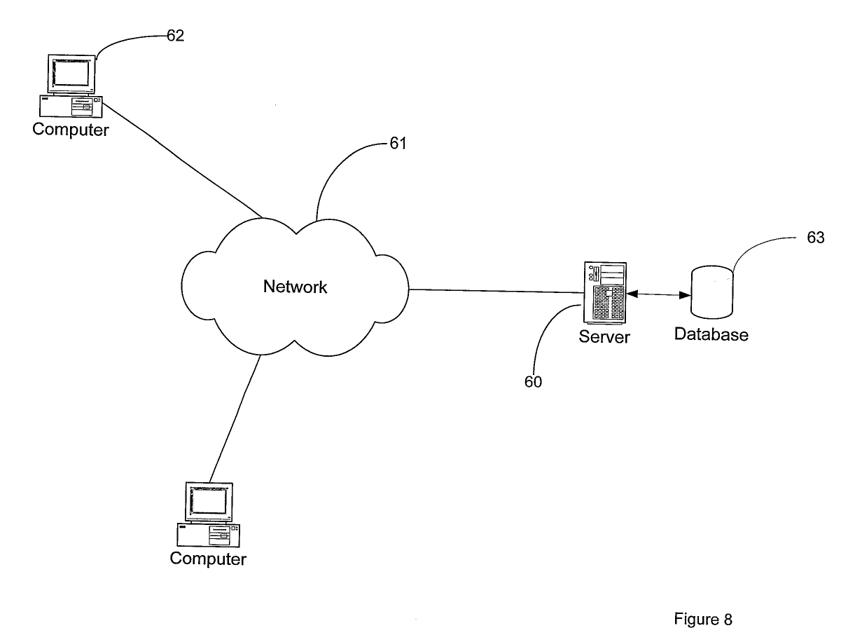

Referring to FIG. 8, a deployment of the system will be shown.

A server 60 records data relating to all employees within the organisation.

A computer 62 can connect to the server 60 via a LAN or the Internet 61. The user on computer 62 sets factor levels for the employees within a GUI. Computer 62 transmits the factor levels to the server.

It will be appreciated that the GUI may be programmed in Java or C++ or any other appropriate programming language,

It will be appreciated that other levels for other attributes could be set.

The server 60 collates the factors within a database 63.

It will be appreciated that other deployments scenarios, such as within one computing device, are envisioned.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1.-27. (canceled)

28. A computer implemented method of managing talent including the steps of:
i) a user dragging an icon representing an individual within a continuum of one or more dimensions to record the value of one or more attributes of the individual; and
ii) automatically refining the position of the icon within the continuum with reference to an objective standard;
wherein each dimension corresponds to an attribute.

29. A method as claimed in claim 28 including the step of obtaining the objective standard through the use of a pre-defined questionnaire.

30. A method as claimed in claim 28 wherein the attributes are related to human resource metrics.

31. A method as claimed in claim 28 wherein the continuum is a one dimension slider.

32. A method as claimed in claim 28 wherein the continuum is a two dimension grid.

33. A method as claimed in claim 28 including the step of displaying a plurality of icons within the continuum, each icon representing a unique individual.

34. A method as claimed in claim 28 including the step of displaying a plurality of historical icons, the position of each icon corresponding to the historical values of the attributes for the individual.

35. A method as claimed in claim 34 wherein at least some of the historical icons are visually faded dependent on the age of the historical values.

36. A method as claimed in claim 34 wherein the step of displaying a plurality of historical icons is dependent on a user action.

37. A method as claimed in claim 36 wherein the user action is placing a pointer over the icon.

38. A method as claimed in claim 36 wherein the user action is activating the icon.

39. A method as claimed in claim 28 wherein the step of refining the position of the icon utilizes a questionnaire to increase the accuracy of positioning of the icon.

40. A method as claimed in claim 28 including the step of displaying further detail about the individual in response to a user action.

41. A method as claimed in claim 40 wherein the user action is placing a pointer over the icon.

42. A method as claimed in claim 40 wherein the user action is activation of the icon.

43. A method as claimed in claim 28 including the step of displaying a plurality of sliders within a single window, each slider corresponding to a unique attribute and each slider including the display of an icon representing the individual, such that a user can assess multiple attributes of the individual at one time.

44. A method as claimed in claim 28 wherein the attributes relate to performance metrics.

45. A method as claimed in claim 28 wherein the attributes relate to potential metrics.

46. A method as claimed in claim 28 including the step of displaying a plurality of icons within the continuum, each icon representing an attribute value provided by a different individual.

47. A computer implemented method of analyzing an individual for managing talent including the steps of:
i) displaying a first graphical representation of a first set of data of an individual in a first shade of a colour on a graph; and
ii) displaying a second graphical representation of a second set of data for the individual in a second shade of the colour on the graph;
wherein the first set of data relates to an analysis of the individual at an later time than the second set of data, and the second shade is lighter than the first shade.

48. A method as claimed in claim 47 wherein the first and second graphical representations are icons.

49. A system for managing talent including:
a display device arranged for displaying an icon representing an individual within a continuum of one or more dimensions and displaying information relating to an objective standard;
a processor arranged for recording the value of one or more attributes of the individual in response to a first input from a user and automatically refining the position of the icon within the continuum with reference to the objective standard in response to a second input from a user;
an input device arranged for receiving the first input from a user dragging an icon within the continuum to provide the value of one or more attributes and receiving the second input from a user to refine the position of the icon;
wherein each dimension of the continuum corresponds to an attribute.

50. Software for managing talent including:
a module arranged for receiving input from a user to drag an icon representing an individual within a continuum of one or more dimensions to record the value of one or more attributes of the individual; and
a module arranged for automatically refining the position of the icon within the continuum with reference to an objective standard;
wherein each dimension corresponds to an attribute.

51. A system arranged for performing the method of claim 28.

52. Software arranged for performing the method of claim 28.

53. Software media storing software as claimed in claim 50.

54. A computer implemented method or system for managing talent within an organization substantially as herein described with reference to FIGS. 1 to 7.

55. A computer implemented method of managing talent including the steps of:
displaying multiple icons associated with the rating of a single individual on a single continuum, wherein the multiple icons are positioned on the continuum based on ratings from separate sources.

56. The method of claim 55, wherein one of the ratings is a self-rating, and the self-rating is shown as a larger icon than the other icons.

57. The method of claim 55 further including the step of displaying an icon representing a final rating, where the position of the final rating is based on the positions of the multiple icons.
